(19) United States
(12) Patent Application Publication
(10) Pub. No.: US 2007/0252423 A1
(43) Pub. Date: Nov. 1, 2007

(54) Trim Panel for a Displaceable Seat

(75) Inventors: Volkmar Schulz, Sindelfingen (DE); Thomas Folster, Grafenau (DE); Thorsten Helbig, Stuttagart (DE); Thomas Heckmann, Aidlingen (DE)

Correspondence Address: FOLEY & LARDNER LLP, 777 EAST WISCONSIN AVENUE, MILWAUKEE, WI, 53202-5306, US

(73) Assignee: JOHNSON CONTROLS GMBH, BURSCHEID (DE)

(21) Appl. No.: 10/582,821

(22) PCT Filed: Dec. 10, 2004
(86) PCT No.: PCT/EP04/14056

§ 371 Date: May 18, 2007

(30) Foreign Application Priority Data
Dec. 15, 2003 (DE) 103 59 019.6

(51) Int. Cl. B60N 2/58

(52) U.S. Cl. 297/452.38

(57) ABSTRACT

Provided is a trim panel suitable for attachment to a displaceable seat, and a seat. The seat has a seat substructure with a first part and a second part and a seat component. The seat component is moveable with the first part in a horizontal direction relative to the second part of the seat substructure and displaceable relative to the first part in a second direction. The trim panel is configured to be attached to the seat component and to be displaceable with the seat component for concealing parts of the seat substructure from normal viewing angle by a user.

### CROSS-REFERENCE TO RELATED PATENT APPLICATIONS

The present Application is a National Phase Application of PCT/EP2004/014056 entitled, “Trim Panel, Suitable for Attaching to a Displaceable Seat, and Seat” filed on Dec. 10, 2004 which published under PCT Article 21(2) on Jun. 23, 2005 as WO 2005/056331 A1 in the German language, which claims priority to German Patent Application DE 103 59 019.6 filed Dec. 15, 2003, the entire disclosure of which, including the specification and drawings, is expressly incorporated herein by reference.

### BACKGROUND

The invention relates to a trim panel. More specifically, the present invention relates to a trim panel suitable for attaching to a displaceable seat, the seat having a seat component which can be displaced relative to a seat substructure.

Displaceable vehicle seats are known. In such conventional displaceable vehicle seats, parts of the seat structure (e.g., substructure) or the displacing device of the seat are often visible laterally below the seat cushion. Since these elements (often metal) are generally considered to be unsightly, they are frequently concealed, particularly in higher-value vehicles. For this purpose, coverings or panels are provided on the structure and/or the cushion shell. The coverings or panels are fastened to the structure or to the seat displacer by means of fastening elements which require complicated and expensive installation operations. In the process, panels are frequently damaged and have to be removed and replaced in a time-consuming process. For example, the publication DE 36 23 634 C2 discloses a seat which has a supporting frame, a spring system fastened to the supporting frame, an upholstery arranged above the spring system, a side panel and a cover covering the upholstery, with the edges of the cover being stretched towards the supporting frame in order to obtain a spring preload. In this connection, resilient (i.e. movable) parts (e.g., the cover or the panel, etc.) are connected to parts fixed on the structure or fixed on the vehicle by a connecting component. In the case of a movement or in the case of a spring deflection, the connecting component is subjected to extremely high mechanical loads and therefore also to a high degree of wear. In the case of a displacement (e.g. an adjustment in inclination), the covering or panel is then deformed.

It is generally known to provide a vehicle seat with a trim panel which is fixed on the structure and moves relative to a seat cushion, and can be adjusted in height and in inclination. The known device has the disadvantage of a very high degree of wear occurring at the transition between the movable seat cushions and the panel fixed on the structure or fixed on the vehicle due to continuous friction. Gaps and points of abrasion at the transition point, therefore, have a negative effect either esthetically or on the service life. In addition, known panels of this type which are fixed on the structure, have to be extremely accurate in their fitting, especially at the transition point, and therefore can only be produced in a highly complicated and expensive manner.

Therefore it is desirable to provide a trim panel suitable for attaching to a displaceable seat, and a seat, the trim panel and seat avoiding the disadvantages of the prior art.

### SUMMARY

One exemplary embodiment relates to a trim panel. The trim panel is suitable for attaching to a displaceable seat, the seat having a seat component which can be displaced relative to a first part of a seat substructure. The first part of the seat substructure is movable substantially horizontally together with the displaceable seat component relative to a second part of the seat substructure. The trim panel largely conceals at least the first part of the seat substructure and is displaceable together with the displaceable seat component. The trim panel is configured to move freely together with the displaceable seat component. This free movement allows the trim panel to avoid excessive mechanical loadings in the interior of the trim panel attributable to the fact that the trim panel would have to elastically absorb and compensate for the entire displacement of the displaceable seat component if not freely movable. In this respect, less exacting demands are required of the trim panel in respect to stability or wear resistance due to material stresses, which are to be absorbed elastically and have a comparatively large amplitude, caused by the displacement of the seat component. Nevertheless, the trim panel has to absorb forces, for example those which are caused by a user sitting down on the edge of the seat part of the seat. According to one embodiment it is advantageously possible to configure the trim panel in a simple manner to be of such stiffness and stability that forces of this type caused by a user can easily be absorbed because the trim panel does not have to have a high elasticity over comparatively large deformation amplitudes and over the entire service life of the vehicle. According to such an embodiment, it is possible that comparatively large tolerances can be provided between the trim panel and the seat substructure or parts or components fixed on the structure or fixed on the vehicle since the trim panel largely conceals the seat substructure. As such, the requirements with regard to the accurate fitting of the trim panel can be comparatively less exact, which reduces the production costs of the trim panel. The trim panel is also referred to below as support part.

According to another exemplary embodiment, the seat component comprises a seat cushion and/or a seat shell. The trim panel is attached to the seat cushion, for example to the upholstery frame or spring frame of the seat surface of the seat, or to the seat shell, and is fastened elastically within limits. According to one embodiment, the trim panel is attached to a point of the seat that permits the maximum amount of construction space or space for accommodating the seat substructure concealed by the trim panel. The seat substructure can therefore be designed in such a manner that allows both a large functional scope with regard to the displacement possibilities of the displaceable seat component, and for the seat substructure to be produced simply and robustly.

According to another exemplary embodiment, the first part of the seat substructure has at least a frame essentially encircling the seat shell, the frame preferably running in the plane of the seat shell. In such embodiment, the seat structure is configured in a simple and stable manner and to provide the seat shell with a comparatively large possibility of movement.

According to another exemplary embodiment, at least part of the seat component to has a decorative surface, the decorative surface at least partially covering the trim panel. Providing such a decorative surface gives a uniform external appearance to the trim panel together with the seat, which improves the overall esthetic impression of the seat. Such an embodiment allows the trim panel to be produced more simply and more cost-effectively because the trim panel is not directly visible or cannot be seen, for example, by a user, at least in his normal viewing direction. A trim panel of this type can therefore be produced with a lower logistical outlay because its surface does not have to be configured, for example, as a decorative surface and because, for example, the same coloring can be used for all of the decorative surfaces used.

According to another exemplary embodiment, the trim panel has locking elements for locking the decorative surface in place in order to design the decorative surface in an esthetically attractive manner without excessively large areas of the decorative surface that are not locked with respect to a direction perpendicular to this surface.

According to another exemplary embodiment, the trim panel has stiffening elements, in particular in the form of ribs which confer particularly great stability and durability on the trim panel.

According to another exemplary embodiment, the trim panel covers at least the first part of the seat substructure at least partially in the manner of a skirt and in the normal viewing direction of a user. In this embodiment, the trim panel can be fastened to the seat in a particularly simple and stable manner.

Another exemplary embodiment relates to a displaceable seat. The displaceable seat comprises a seat substructure and a displaceable seat component, the seat having a trim panel according to the invention. According to this particular embodiment, a seat of this type can be designed in a more cost-effective and esthetically attractive manner.

According to another exemplary embodiment, the displaceable seat component can be adjusted in inclination and/or can be adjusted in height relative to the first part of the seat substructure. This ensures that the seat provides a user with a maximum degree of comfort and setting possibilities.

According to another exemplary embodiment, the trim panel at least on one side of the seat conceals at least the first part of the seat substructure from a lateral viewing direction. Such an embodiment allows the trim panel to give the seat a particularly attractive external appearance to a certain extent “on first view” because a side view of the seat is generally the first view which is visible of a vehicle or of a vehicle seat after a vehicle door is opened.

### BRIEF DESCRIPTION OF THE DRAWINGS

Exemplary embodiments of the trim panel and the vehicle seat are explained below with reference to drawings.

FIG. 1 is a perspective view of a conventional vehicle seat.

FIG. 2 is a perspective view of a seat according to an exemplary embodiment, shown with the seat upholstery removed.

FIG. 2a is a perspective view of the seat of FIG. 2, shown without the trim panel.

FIG. 3 is a perspective view of the seat of FIG. 2.

FIG. 4 is a bottom perspective view of a trim panel according to an exemplary embodiment.

FIG. 5 is a top perspective view of the trim panel of FIG. 4.

FIG. 6 is a cross-sectional view of the seat of FIG. 3.

FIG. 7 is a detailed perspective view of the trim panel.

FIG. 8 is a side view of the trim panel.

### DETAILED DESCRIPTION

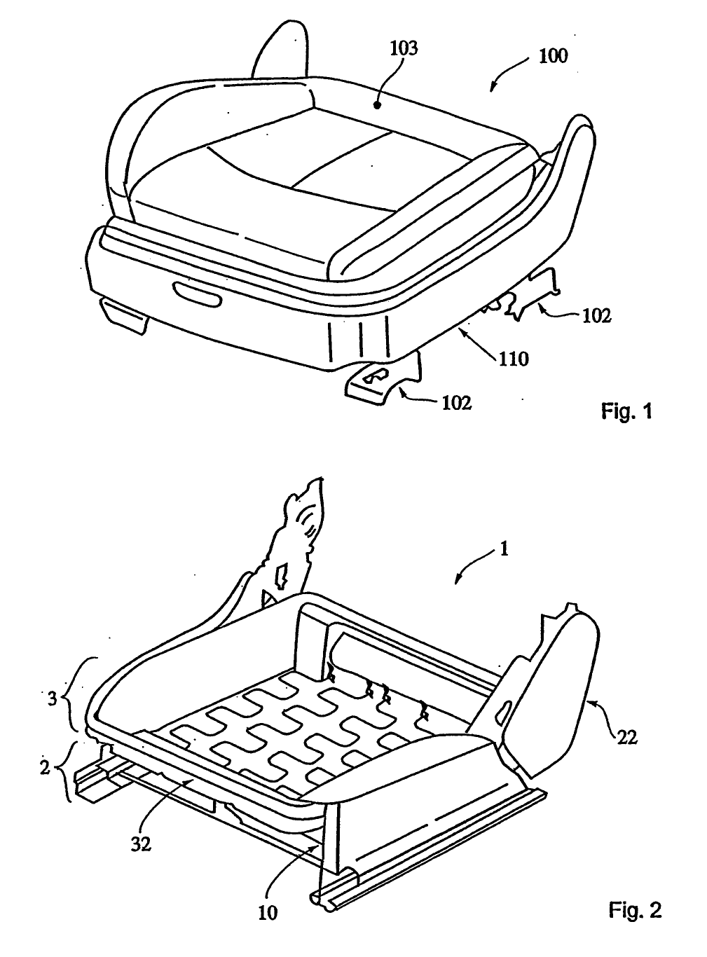

FIG. 1 illustrates a vehicle seat 100 which is conventional and known, at least in parts. A trim panel or a panel 110 is arranged around a known seat part 103, with the panel 110 being fastened in a fixed manner to the substructure 102 of the seat 100. The seat part 103 or the cushion 103 moves relative to the panel 110, and for example can be adjusted in height and/or inclination. This results in increased abrasion or an increased wear at the contact points between the cushion 103 and the panel 110 (possibly as a function of the inclination or height which is set). If the panel 110 comprises a plurality of parts, they have to be produced to fit extremely accurately with respect to one another, which makes the panel more expensive and causes a reduction in the service life.

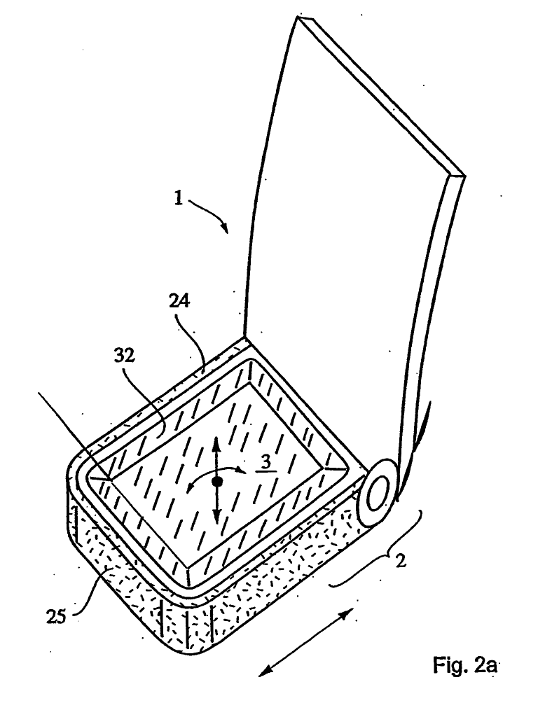

Parts of a vehicle seat 1 or a trim panel 10 according to one exemplary embodiment are illustrated in FIGS. 2-6.

FIGS. 2 and 2a each illustrate a perspective view of part of the seat I with the seat upholstery removed. FIG. 2 also illustrates a trim panel 10. The trim panel 10 is not illustrated in FIG. 2a. As a result, FIG. 2a more clearly reveals that a seat has, in particular, a displaceable seat component 3, for example a seat shell 32, which is displaceable in relation to at least a first part 25 of a seat substructure 2. In an exemplary embodiment the displaceable seat component 3 can adjust in inclination and/or height in relation to the first part 25 of the seat substructure 2. In this embodiment, the first part 25 of the seat substructure 2 has a frame 24 which extends in the plane of the seat shell 32 or of the displaceable seat component 3. For the sake of simplicity, the illustration in FIG. 2 does not contain a seat cushion or seat upholstery. The seat 1 comprises the seat substructure 2 and the displaceable seat component 3. The displaceable seat component 3 can be adjusted in height and/or can be adjusted in length and/or can be adjusted in inclination relative at least to parts of the seat substructure 2. According to the invention, the trim panel 10 is used for the lateral cladding or covering on the seat 1. The trim panel 10 therefore fulfills the function of a support part which prevents a user of the vehicle seat from looking with respect to normal viewing directions at the seat substructure 2. In the case of a vehicle seat 1 parts of the structure or a displacement device of the seat 1 are arranged laterally below the seat cushion.

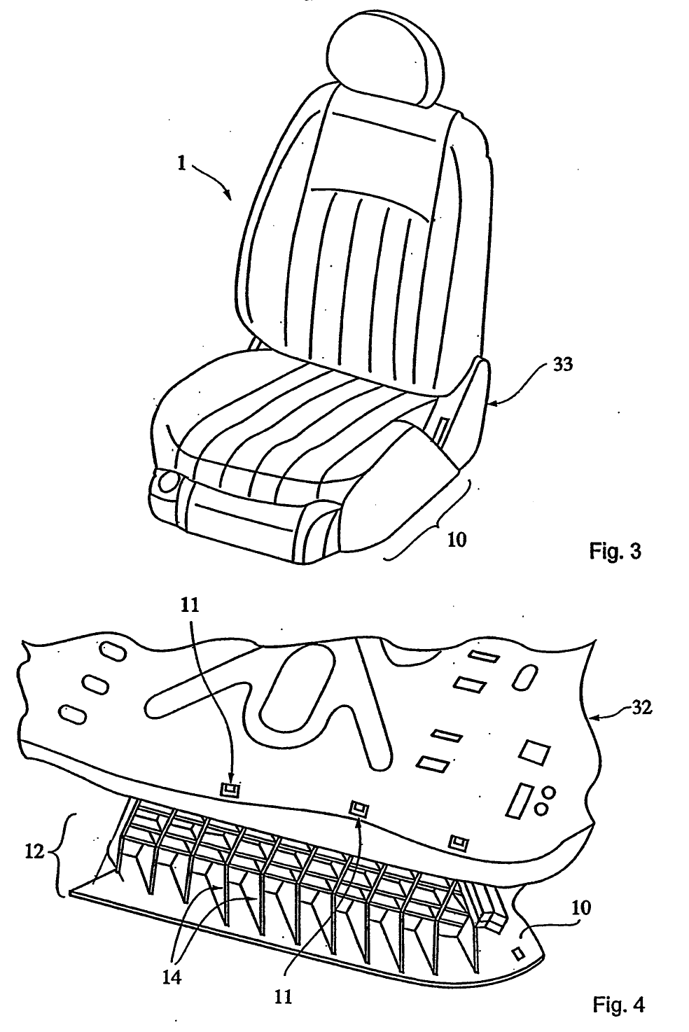

The entire vehicle seat 1 and trim panel 10 illustrated in FIG. 3 are covered by means of a decorative material or by means of a decorative surface 33, resulting in a uniform exterior providing an advantageous appearance of seat 1.

The trim panel 10 as illustrated from below the seat 1 or the seat shell 32 in FIG. 4 is fastened to the seat shell 32 by means of fastening elements 11, for example screws, clips, rivets and the like. According to an alternative embodiment, the trim panel 10 could attach to a seat from or spring frame instead of the seat shell 32. The trim panel 10 covers the seat 1 (or in particular the substructure 2 of the seat 1) at the lateral region 12 (but possibly also front and/or rear region) in the manner of a skirt, so that below the seat shell 32 there is sufficient space for the displacement mechanism of the seat 1 and, the displacement mechanism or the parts of the seat substructure 2 is/are protected in an esthetic manner from view from a normal viewing angle. Stiffening elements 14 of the trim panel 10 which, in the exemplary embodiment, are designed as ribs or stiffening ribs 14 are visible in FIG. 4.

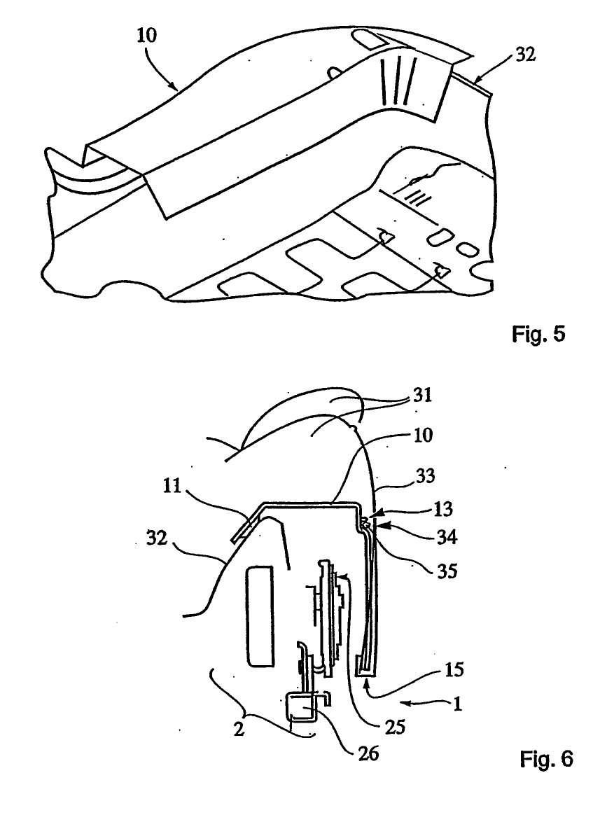

The trim panel in FIG. 5 is illustrated without the seat upholstery. The trim panel 10 is attached in turn to the seat shell 32 or the upholstery frame of the seat 1.

FIG. 6 illustrates a cross-sectional view of a vehicle seat 1 with a trim panel 10 according to the invention. Again, the seat shell 32 is illustrated with the trim panel 10 fastened to it via fastening elements 11. Different parts or components of the seat substructure 2 can likewise be seen. In this case, the seat substructure 2 is referred to in summary by the reference number 2. However, the first part 25 of the seat substructure 2 is movable together with the displaceable seat component 3 or together with the seat shell 32 horizontally, in particular in a longitudinal direction of the vehicle, in relation to a second part 26 of the seat substructure 2 or in relation to the vehicle body.

Various contours in various cross-sectional planes of the seat cushion 31 are likewise illustrated in FIG. 6. The seat cushion 31 is covered by means of a decorative surface 33, with the decorative surface 33 also covering the trim panel 10 in addition to the seat cushion 31, resulting in an uniform and esthetic design of the seat 1. All customary decorative materials, such as, for example, woven fabric, leather, knitted fabric, films and the like can be used as the decorative surface 33. Particularly suitable as material of the trim panel 10 are plastics, as are used in molded plastic parts in the interior of a motor vehicle.

According to an exemplary embodiment, the decorative surface 33 is locked or to fastened to the trim panel 10 in an effort to avoid excessively large areas covered by the decorative surface 33. Without locking or fastening the decorative surface 33, covering excessively large areas of the trim panel with the decorative surface 33 may have a negative esthetic effect and, may lead to the decorative surface 33 deforming (e.g., going wavy, not resting smoothly against the trim panel 10, etc.) and causing creases. To avoid such disadvantages, locking elements 13 are provided on the trim panel 10. The locking elements 13 lock the decorative surface 33 in place at least in a direction perpendicular to the surface which it covers. To assist in securing the decorative surface 33 to the locking elements 13, the decorative surface 33 has a locking means 34 which is complementary to the locking elements 13. For example, the locking means 34 may be in the form a loop into which a wire 35 is sewn in the longitudinal direction of the seat or of the vehicle (i.e. running perpendicularly to the plane of projection in FIG. 6), with the sewn-in wire 35 being able to be locked in place by means of the locking elements 13, for example by clipping in, pushing in, latching in or the like. In such an embodiment, the locking elements 13 can be designed, for example, as fastening hooks or fastening clips. At the lower end 15 of the trim panel 10, the decorative surface 33 is connected to the trim panel 10 in a conventional manner, for example by means of fastening holes or fastening hooks by means of a hook-in strip.

During assembly, the trim panel 10, which is also referred to below as bracing part 10, is fastened to the seat shell 32 or the cushion shell 32, for example with hollow rivets as fastening elements 11. In a preferred embodiment, the seat cushion 31 or foam part 31 is then placed on and subsequently the decorative surface 33 or the cover 33 is placed above the seat cushion 31 and fastened at all necessary fastening points, in particular by means of the locking elements 13 or at the lower end 15 of the trim panel 10. In this embodiment, the trim panel 10 moves together with the seat shell 32, so that no abrasion or the like arises. Since the surface of the trim panel 10 is concealed by the decorative surface 33, it does not matter whether, during installation of the trim panel 10, scratches arise on the latter. Furthermore, due to the comparatively high (dimensional) tolerance of the soft decorative surface 33, high accuracy in fitting the trim panel 10 is not required, resulting in comparatively less stringent requirements in this regard, which makes the trim panel 10 less expensive. If the trim panel 10 is formed from plastic, an integration of fastening elements 11 or of locking elements 13 is facilitated. According to the invention, it is advantageously possible by means of the trim panel 10 for the seat cushion 31 to obtain a good support or a good base which, in particular when a person gets into or out of the vehicle, constitutes a stable substructure and prevents the seat cushion 31 or the seat foam 31 from tilting. As an alternative to forming the trim panel 10 from plastic, it is also possible to provide the trim panel 10 as a sheet-metal part—in particular riveted or screwed or welded onto the seat shell 32. Furthermore, it is possible according to the invention to provide the trim panel 10 integrally with the seat shell 32. In an exemplary embodiment a displacement switch (not illustrated) for the seat displacement can be integrated in the trim panel 10.

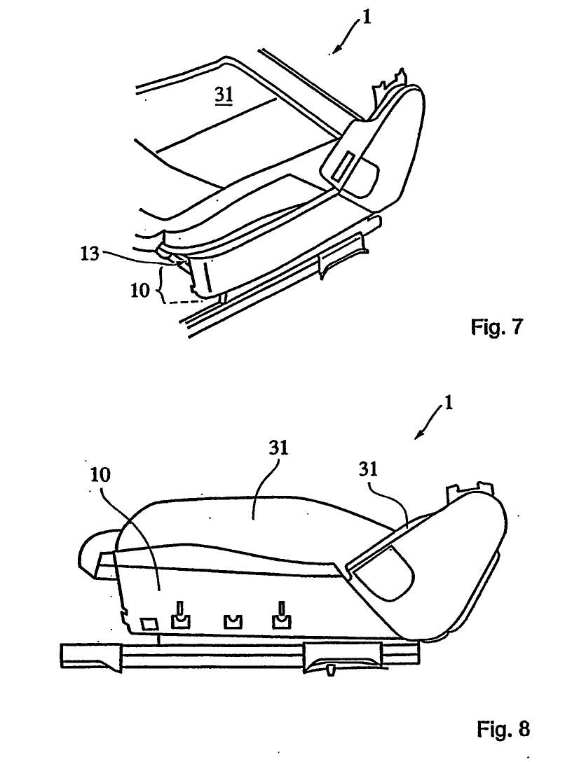

FIG. 7 illustrates a detailed view of the trim panel 10 from a direction laterally from above, and FIG. 8 illustrates a detailed view of the trim panel 10 as seen from the side. The seat cushion 31 can be seen in both figures. In FIG. 7, the profile of the complimentary locking means 13 and locking means 34 of the decorative surface 33 in the longitudinal direction of the seat or of the vehicle can be seen.

1-12. (canceled)

13. A trim panel for use with a vehicle seat having a seat component which can be displaced relative to at least a first part of a seat substructure, the first part of the seat substructure being movable in a substantially horizontal direction together with the seat component relative to a second part of the seat substructure, the trim panel comprising:
a support part attachable to the seat component and configured to substantially conceal at least the first part of the seat substructure;
wherein the support part is displaceable with the seat component when attached to the seat component.

14. The trim panel of claim 13, further comprising a decorative surface that at least partially covers the support part.

15. The trim panel of claim 14, wherein the support part comprises locking elements for locking a decorative surface in place.

16. The trim panel of claim 13, wherein the support part further comprises stiffening elements.

17. The trim panel of claim 16, wherein the stiffening elements are ribs.

18. A vehicle seat comprising:
a seat substructure having a first part and a second part, the first part being movable in a horizontal direction relative to the second part;
a seat component movable with the first part in the horizontal direction and displaceable relative to the first part in a second direction; and
a trim panel attached to the seat component,
wherein the trim panel is displaceable with the seat component and substantially conceals the first part of the seat substructure.

19. The vehicle seat of claim 18, wherein the second direction is at least one of a vertical direction for adjusting height and an angular direction for adjusting inclination.

20. The vehicle seat of claim 18, wherein the trim panel is a skirt downwardly extending from a lateral edge of the seat component.

21. The vehicle seat of claim 18, wherein the seat component comprises a seat cushion.

22. The vehicle seat of claim 18 wherein the seat component comprises a seat shell.

23. The vehicle seat of claim 22, wherein the first part of the seat substructure has a frame substantially encircling the seat shell.

24. The vehicle seat of claim 23 wherein the frame runs substantially in the plane of the seat shell.

25. The vehicle seat of claim 18, wherein the seat component and trim panel are at least partially covered by a decorative surface.

26. The vehicle seat of claim 25, wherein the trim panel comprises locking elements for locking the decorative surface in place.

27. The vehicle seat of claim 18, wherein the trim panel further comprises stiffening ribs.

28. A vehicle seat comprising:
a seat substructure having a first part and a second part, the first part being movable in a horizontal direction relative to the second part;
a seat component movable with the first part in the horizontal direction and displaceable relative to the first part in a second direction;
a trim panel displaceable with the seat component and downwardly extending therefrom, the trim panel is configured to substantially conceal the first part of the seat substructure;
a decorative surface at least partially covering the seat component and trim panel, and
a locking element provide at the trim panel for securing the decorative surface in place.

29. The vehicle seat of claim 28, wherein the trim panel comprises stiffening elements.

30. The vehicle seat of claim 29, wherein the stiffening elements are ribs.

31. The vehicle seat of claim 29, wherein the second direction is at least one of a vertical direction for adjusting height and an angular direction for adjusting inclination.

32. The trim panel of claim 28, wherein the support part conceals at least the first part of the seat substructure from a lateral view.
